(19) United States
(12) Patent Application Publication
(10) Pub. No.: US 2010/0143131 A1
(43) Pub. Date: Jun. 10, 2010

(54) Folding blade turbine

(75) Inventor: John Pitre, Honolulu, HI (US)

Correspondence Address: STEPTOE & JOHNSON LLP, 1330 CONNECTICUT AVENUE, N.W., WASHINGTON, DC, 20036, US

(73) Assignee: Natural Power Concepts, Inc., Honolulu, HI (US)

(21) Appl. No.: 12/461,716

(22) Filed: Aug. 21, 2009

Related U.S. Application Data
(60) Provisional application No. 61/202,189, filed on Feb. 4, 2009.
(60) Provisional application No. 61/189,950, filed on Aug. 22, 2008.

(51) Int. Cl. F03D 7/02; F03D 11/04; F03B 13/14; F03B 3/14

(52) U.S. Cl. 416/85; 416/147

(57) ABSTRACT

A turbine has airfoils that are configured to extract work from a prevailing fluid flow. An actuator causes the airfoils to pivot or fold between a first position with their spans substantially normal to the flow direction and a second position with their spans substantially parallel to the flow direction, or any position in between. The variable geometry allows the airfoils to be sized for relatively light winds and to remain operational in relatively high winds without damage. Under extreme conditions the airfoils may be folded completely for safety.

### CROSS-REFERENCE TO RELATED APPLICATIONS

This application claims priority to U.S. Provisional Patent Applications 61/189,950 entitled, “Fine Arts Innovations,” and filed Aug. 22, 2008, and 61/202,189 entitled “Folding Blade Turbine,” and filed Feb. 4, 2009, the disclosures of which are expressly incorporated herein by reference in their entireties.

### STATEMENT REGARDING FEDERALLY SPONSORED RESEARCH OR DEVELOPMENT

None.

### NAMES OF THE PARTIES TO A JOINT RESEARCH AGREEMENT

None.

### BACKGROUND

According to the U.S. Department of Energy, modern, wind-driven electricity generators were born in the late 1970's. See “20% Wind Energy by 2030,” U.S. Department of Energy, July 2008. Until the early 1970s, wind energy filled a small niche market supplying mechanical power for grinding grain and pumping water, as well as electricity for rural battery charging. With the exception of battery chargers and rare experiments with larger electricity-producing machines, the windmills of 1850 and even 1950 differed very little from the primitive devices from which they were derived. As of July 2008, wind energy provides approximately 1% of total U.S. electricity generation.

As illustrated in FIG. 1, most modern wind turbines typically have 3-bladed rotors 10 with diameters of 10-80 meters mounted atop 60-80 meter towers 12. The average turbine installed in the United States in 2006 can produce approximately 1.6 megawatts of electrical power. Turbine power output is controlled by rotating the blades 10 around their long axis to change the angle of attack (pitch) with respect to the relative wind as the blades spin around the rotor hub 11. The turbine is pointed into the wind by rotating the nacelle 13 around the tower (yaw). Turbines are typically installed in arrays (farms) of 30-150 machines. A pitch controller (for blade pitch) regulates the power output and rotor speed to prevent overloading the structural components. Generally, a turbine will start producing power in winds of about 5.36 meters/second and reach maximum power output at about 12.52-13.41 meters/second (28-30 miles per hour). The turbine will pitch or feather the blades to stop power production and rotation at about 22.35 meters/second (50 miles per hour).

In the 1980s, an approach of using low-cost parts from other industries produced machinery that usually worked, but was heavy, high-maintenance, and grid-unfriendly. Small-diameter machines were deployed in the California wind corridors, mostly in densely packed arrays that were not aesthetically pleasing in such a rural setting. These densely packed arrays also often blocked the wind from neighboring turbines, producing a great deal of turbulence for the downwind machines. Little was known about structural loads caused by turbulence, which led to the frequent and early failure of critical parts. Reliability and availability suffered as a result.

### SUMMARY

An objective of the invention is to provide an improved turbine capable of operating over a wide range of prevailing wind conditions and surviving storms. Further objects of the invention are:

(i) to provide an improved turbine capable of controlled operation under mild as well as harsh (storm level) wind conditions up to hurricane strength;

(ii) to provide an improved turbine with controllably-variable geometry; and

(iii) to provide an improved turbine with blades that can be controllably folded to between a first position with their spans (lengths from root to tip) generally normal (at right angels) to the prevailing airflow under mild wind conditions and a second position with their spans generally parallel to the prevailing airflow under otherwise overpowering wind conditions.

These and other objectives are achieved by providing an improved, axial-flow turbine with blades that are operable in a fully extended position with their spans oriented generally perpendicular to a prevailing airflow for relatively mild wind conditions. Blades may be folded to a closed position with their spans generally parallel to the prevailing airflow for relatively harsh wind conditions, such as open-ocean storms. An actuation mechanism controllably positions blades across the range from the extended position to partially- or fully-folded positions. The turbine preferably is operable with blades in the extended position and in partially and completely folded positions.

The turbine utilizes a drive shaft for transferring torque from the blades to an electric generator or other energy-utilization device. A sliding shaft that is concentric with the drive shaft connects to a sliding hub and tie rods that control the degree of blade folding. The sliding shaft, sliding hub, and tie rods rotate with the blades so that the turbine remains operable with blades in folded positions.

### BRIEF DESCRIPTION OF THE SEVERAL VIEWS OF THE DRAWING

Reference will be made to the following drawings, which illustrate preferred embodiments of the invention as contemplated by the inventor(s).

FIG. 1 illustrates a prior art wind turbine.

FIGS. 2a and 2b are rear and side views respectively of a folding-blade turbine generator with blades in the fully extended position.

FIGS. 3a and 3b are rear and side views respectively of a folding-blade turbine with blades in the fully folded position.

FIG. 4 is an exploded view of major assemblies of a folding-blade turbine.

FIG. 5 is a partial sectional view of a turbine generator showing blades in the fully extended position.

FIG. 6 is a partial sectional view of a turbine generator showing blades in the fully folded position.

FIG. 7 is an exploded view of a drive assembly for a turbine generator.

FIG. 8 is an exploded view of a sliding assembly for a turbine generator.

FIG. 9 is a sectional view of a coupling between a sliding shaft and an actuator in a turbine generator.

FIG. 10 is an exploded view of a turbine blade in a turbine generator.

FIGS. 11A, 11B, and 11C are side, front, and bottom views respectively of the turbine blade of FIG. 10.

FIG. 12 is a cross sectional view of a rotor and stator of an electricity generator assembly for a turbine generator.

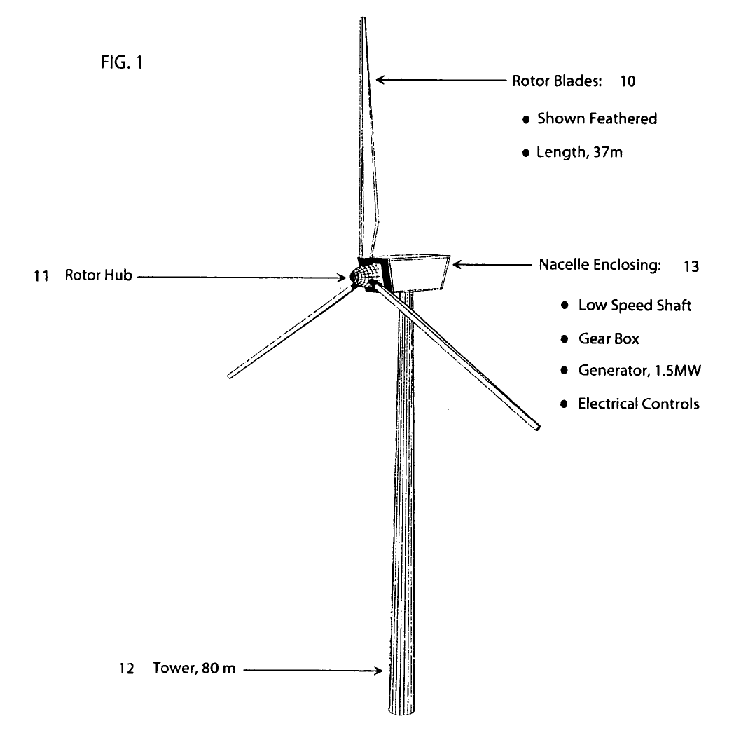

### DETAILED DESCRIPTION OF THE INVENTION

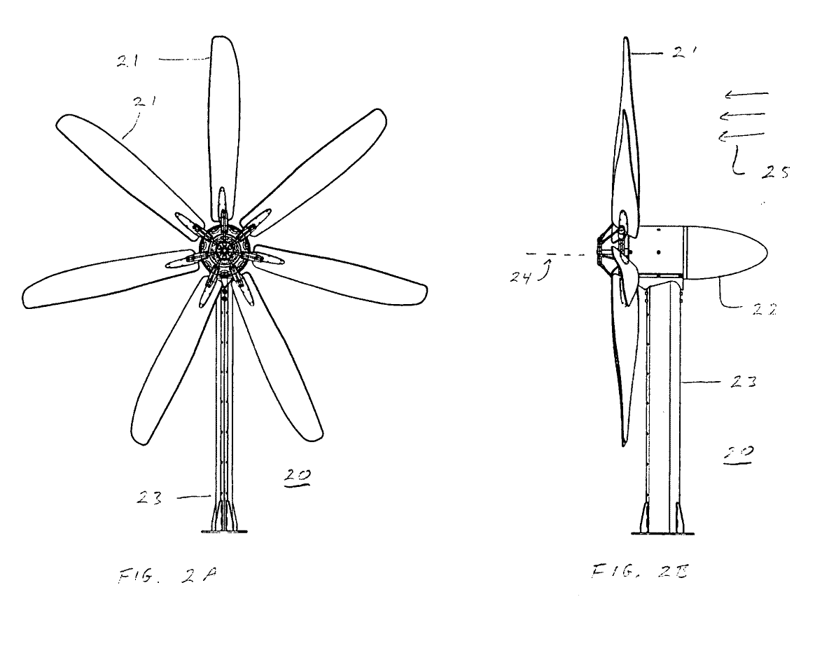

FIGS. 2a and 2b are rear and side views respectively of an exemplary, folding-blade turbine generator 20 with turbine blades 21 in the fully extended position. Blades 21 mount to a shaft (not shown) that is journeled within a nacelle 22. The nacelle 22 mounts to a mast 23, which in turn may be mounted to any of a variety of foundation structures. The mounting may allow the turbine generator to rotate in response to changing wind direction so that the turbine generator (e.g., axis of rotation of the blades) remains pointed along the direction of the prevailing wind.

The turbine may be mounted in any location, but preferred foundations are marine structures, such as an oil drilling platform that has outlived its useful life, or a buoy that may also harvest wave power. Marine locations periodically experience extreme weather conditions such as gale force winds (39-54 mph or 63-87 km/h, sustained) and hurricanes (winds greater than 74 miles per hour, or 119 km/h, sustained).

The turbine blades 21 include airfoils shaped to generate a torque about an axis of rotation 24 in the presence of a prevailing wind 25. The turbine generator shown in FIGS. 2a and 2b may be called an “axial-flow” turbine in that the blades are shaped to rotate when the direction of the prevailing wind 25 is aligned with the axis of rotation 24. Preferably, the blades are shaped for nominal operation when positioned on the downwind side of the nacelle 22. (The terms “forward” and “rearward” in this description refer to upwind and downwind directions respectively when the turbine generator is in this nominal operating position. For example, in normal operation, the blades 21 are “rearward” and “downwind” of the nacelle 22. This designation is for convenience of description only and not intended to limit the scope of the invention.) In the fully extended position, the long axis of the blades along the airfoil span is in a normal direction (right angle) to the direction of the prevailing airflow.

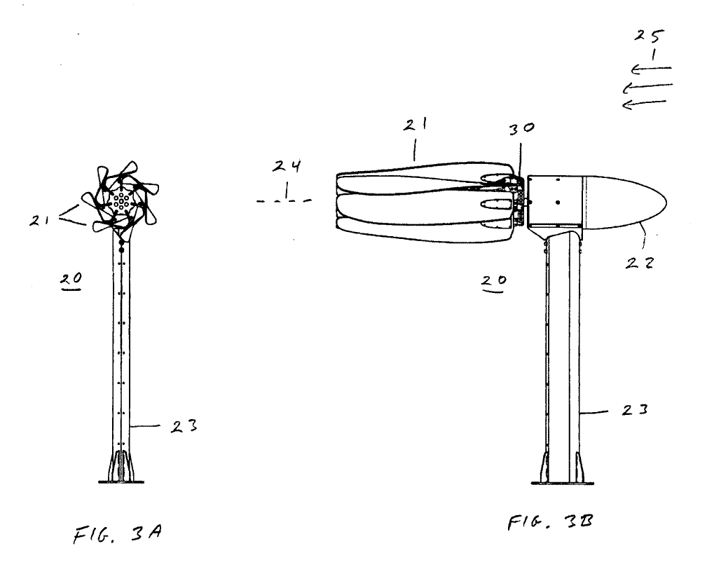

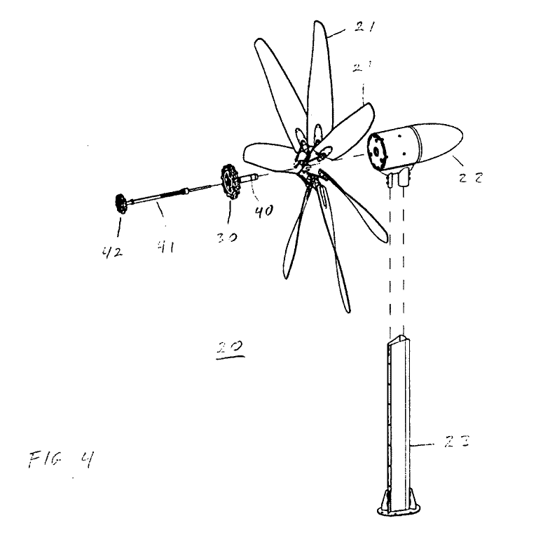

FIGS. 3A and 3B are rear and side views respectively of an exemplary, folding-blade turbine generator 20 with turbine blades 21 in the fully folded position. Here, the long axis of the blades 21 are parallel to the axis of rotation, which also is the direction of the prevailing wind. Each blade 21 is pivotally mounted to a drive hub 30 that rotates with the blades 21. Blades may pivot between extended and folded positions while rotating, as discussed more fully below.

FIG. 4 is an exploded perspective view of major assemblies of the turbine generator 20 of FIGS. 2A, 2B, 3A, and 3B. In addition to previously mentioned blades 21, nacelle 22, mast 23 and drive hub 30, this figure illustrates drive shaft 40, sliding shaft 41, and sliding hub 42. The blades 41 mount pivotally to drive hub 30, which in turn is welded or otherwise affixed to drive shaft 40. Drive shaft 40 in turn is journeled within nacelle 22.

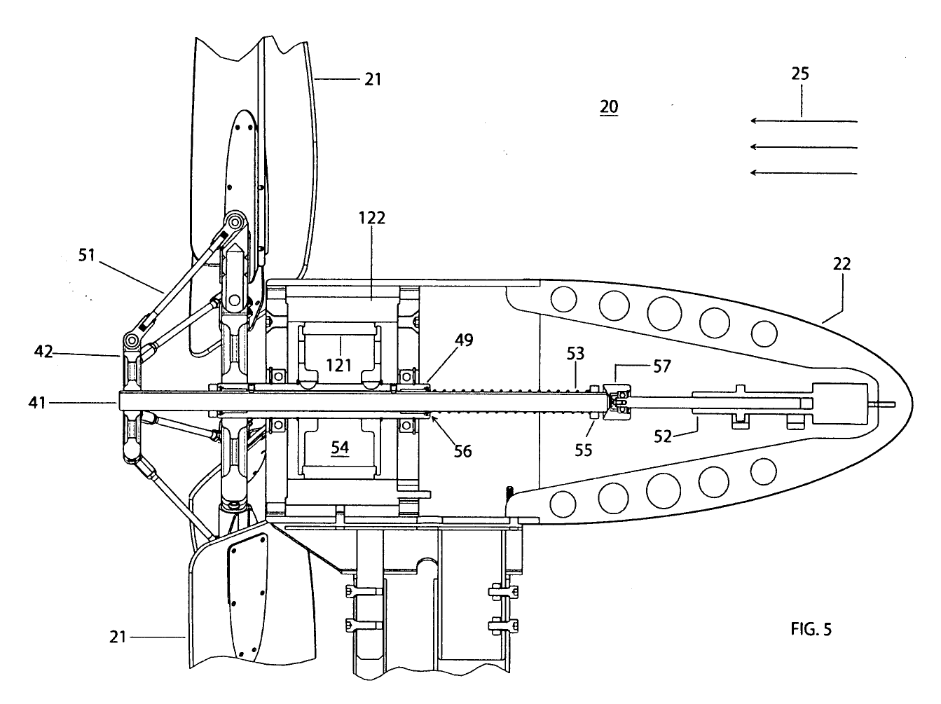

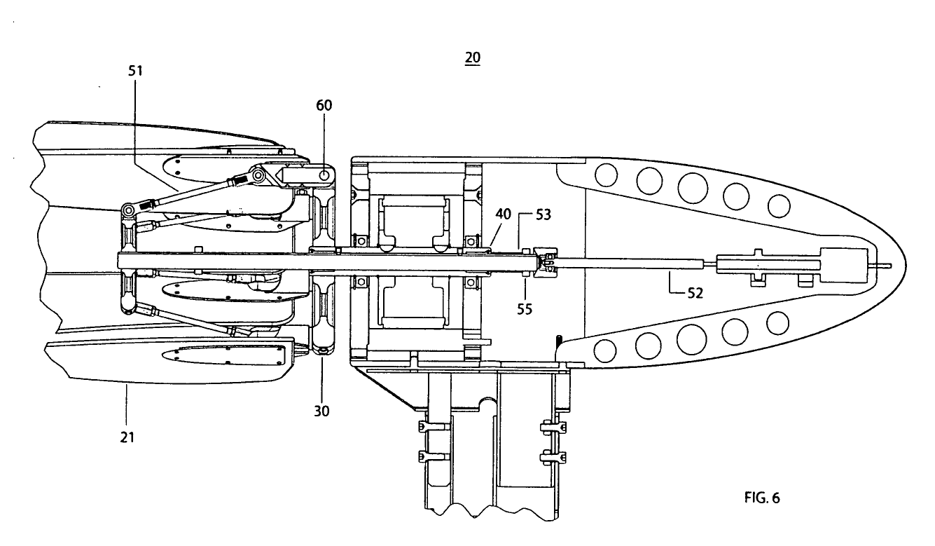

FIG. 5 is a partial sectional view of an exemplary turbine generator 20 showing nacelle 22, drive hub 30, drive shaft 40, sliding shaft 41, and sliding hub 42 with blades 21 in the fully extended position. The sliding shaft 41 is longer than, and concentric with, drive shaft 40. The sliding shaft extends beyond the drive shaft 40 in both the forward (upwind into nacelle 22) and rearward (downwind out of nacelle 22) directions. The sliding hub 42 attaches to the rearward end of sliding shaft 41 on the rearward (downwind) side of drive hub 30. The forward end of sliding shaft 41 couples to an actuator (not shown), which is discussed further below. Tie rods 51 connect sliding hub 42 to blades 21, as will be discussed in further detail below. A generator assembly 54 couples both to the nacelle 22 and to the drive shaft 41, as also will be discussed in further detail below. A spring 53 mounts around the sliding shaft 41 between (i) a forward collar 55 fixed to the sliding shaft 53 near the sliding shaft forward end, and (ii) a seat 56 near the forward end of drive shaft 40. An actuator 52 couples to the forward end of sliding shaft 53, as will also be discussed further below. The actuator is of the linear type with a central shaft that extends and retracts along its long axis, which in the orientation of FIG. 5 is coaxial with sliding shaft 53. Shown with blades in the fully extended position, this figure shows the actuator 52 in a retracted position and sliding shaft 41 in a relatively forward position when compared with FIG. 6. The spring 53 is under relatively mild compression, which biases the sliding shaft forward against a thrust bearing 57 mounted to the rearward end of the actuator 52.

FIG. 6 is a partial sectional view of an exemplary turbine generator 20 showing blades 21 in the fully folded position. Here, actuator 52 is extended in the rearward direction, as are sliding shaft 41 and sliding hub 42 when compared to their positions in FIG. 5. Tie rods 51 are displaced rearward and inward. Blades 21 are pivoted about their drive-hub connections 60 to the folded position. Spring 53 is relatively highly compressed. Drive shaft 40 and drive hub 30 maintain the same axial position relative to those shown in FIG. 5.

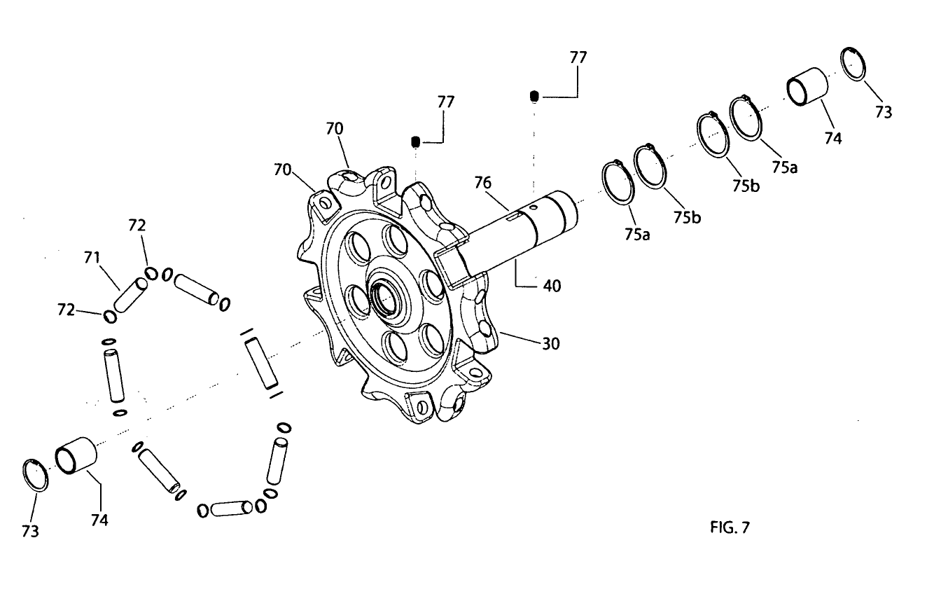

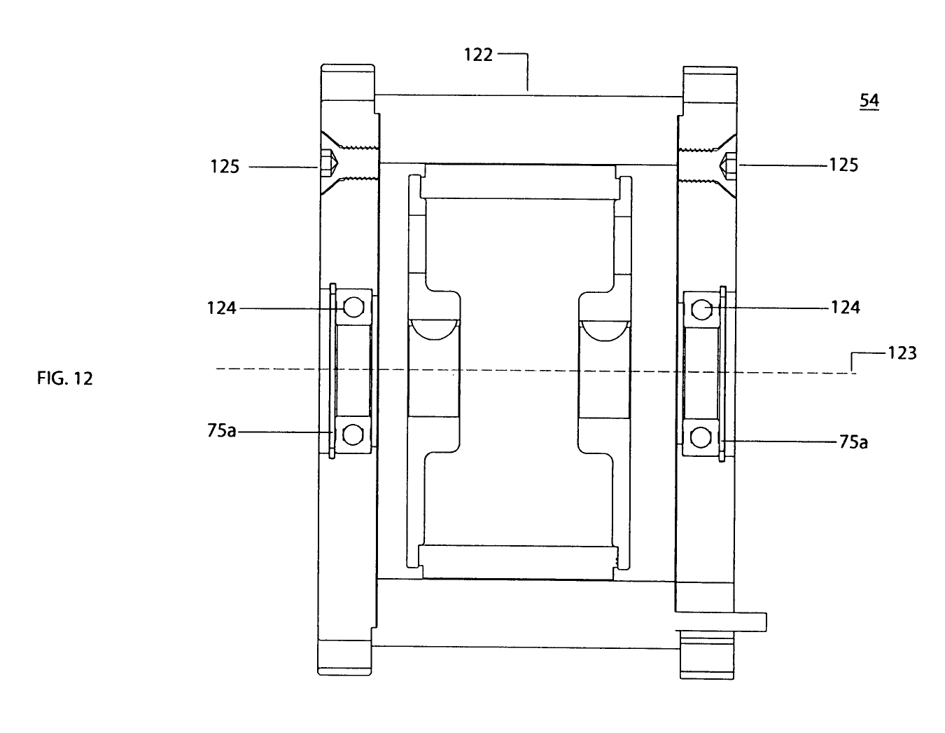

FIG. 7 is an exploded view of an exemplary drive assembly including drive shaft 40 and drive hub 30 as mentioned previously. Drive hub 30 includes a station for each blade (not shown). An exemplary station has mounting holes 70 for pivot pins 71. Each pivot pin 71 passes through a mounting structure on a blade (not shown) and holds a blade pivotally in its station, while rings 72 hold pivot pins in the drive hub 30. Bush rings 73 hold forward and rearward bearings 74 for concentric sliding shaft (not shown). Retaining rings 75a, 75b engage with the generator assembly (FIG. 5, item 54) or other fixed structure to limit axial movement of the drive shaft 40. Slots 76 in the drive shaft 40 are provided to receive keys (FIG. 12, items 125) that lock the drive shaft 40 to the rotor of an electric generator (not shown), as discussed further below. Screws 77 rotationally couple the drive shaft 40 to siding shaft (not shown) while allowing the sliding shaft to move axially relative to the drive shaft 40.

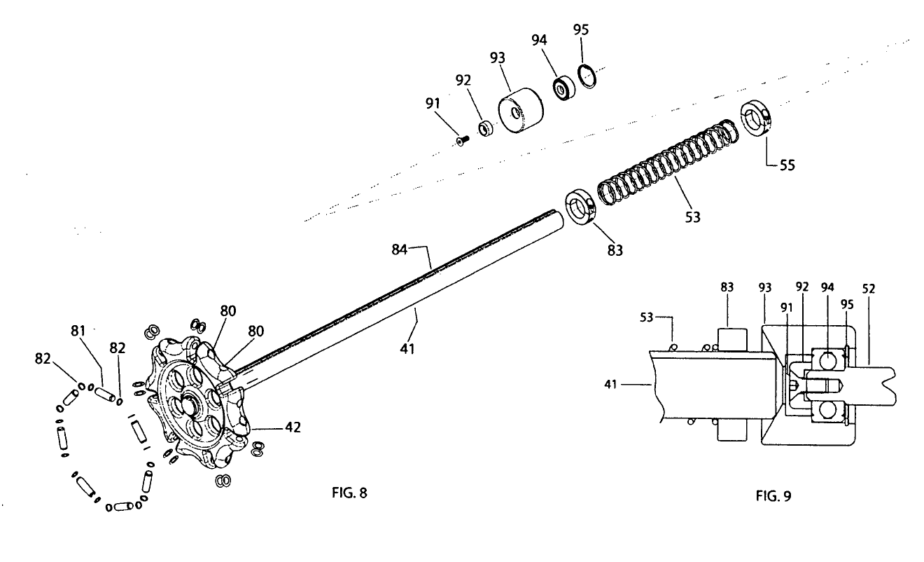

FIG. 8 is an exploded view of an exemplary sliding assembly including sliding shaft 41, sliding hub 42, spring 53 and forward collar 55′ as mentioned previously. Sliding shaft 41 bears an axial groove 84 into which extend screws (FIG. 7, items 77) of the drive shaft assembly, as will be discussed further below. Sliding hub 42 includes stations for each tie rod (not shown) with mounting holes 80 for tie-rod pins 81. Each tie-rod pin 81 passes through a corresponding hole in a tie rod and holds a tie rod pivotally in its station, while rings 82 hold tie-rod pins in the sliding hub 42.

FIG. 9 is a sectional view of an exemplary coupling between sliding shaft 41 and actuator 52. A bolt 91 and cap 92 hold thrust bearing 94 to the actuator 52. Retaining ring 95 holds push plate 93 in place on actuator 52. The forward end of sliding shaft 41 seats in a beveled recess in the rear of the push plate 93.

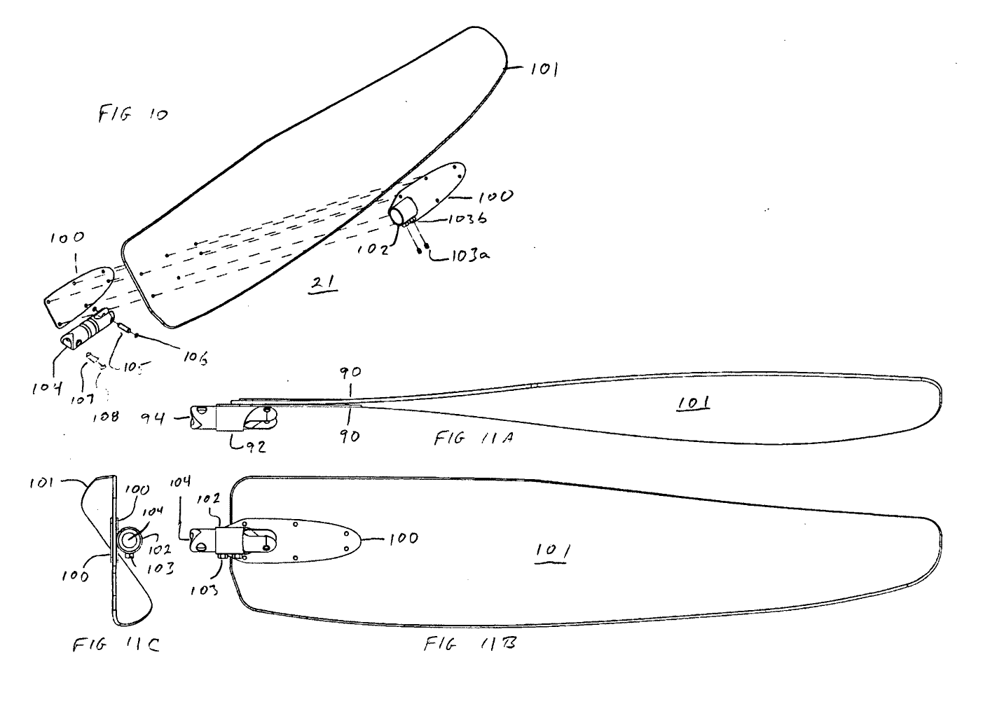

FIG. 10 is an exploded view of an exemplary turbine blade 21, while FIGS. 11A, 11B, and 11C are side, front, and bottom views of the turbine blade of FIG. 10. Complementary clamp plates 100 attach to one another through front and back surfaces of the root of an airfoil 101. One of the clamp plates bears a hollow cylindrical sleeve 102, which has its axis aligned along the airfoil span. Set screws 103a passing through weld nuts 103b attached on the exterior of cylindrical sleeve 102 hold a grooved cylindrical post 104 within the cylindrical sleeve 102. Short lengths of the post 104 are partially drilled out (or were cast to have a central void) along the central axis near the ends. A portion of the post 104 extends beyond the root of the airfoil 101, and radially through that portion runs a first set of mounting holes used to couple the blade to the drive hub. A blade pin (FIG. 7, item 71) passing through the first set of mounting holes and seated in the drive hub (FIG. 5, item 30) couples blades to the drive hub. The opposite end of the post 104 has a second set of radial holes used to couple the blade to a tie rod (not shown). A tie-rod pin 105 passing through a tie rod (FIG. 5, item 51) and seated in the second set of mounting holes couples blades to tie rods. This arrangement is by way of example only, and other arrangements for mounting blades may be used.

FIG. 12 illustrates an exemplary generator assembly 54, which was mentioned above in connection with FIG. 5. The generator assembly 54 includes a rotor 121 and a stator 122. The rotor 121 preferably includes permanent magnets or electromagnets, while the stator 122 preferably includes electrically conductive coils. The stator 122 is fixed relative to the nacelle 22 while the rotor 121 rotates about a central axis 123. When assembled, retaining rings 75a hold bearings 124 in the alternator housing support and allow rotation of the drive shaft (not shown) about the central axis 123. Keys 125 in the rotor 121 mate with slots in the drive shaft (FIG. 7, item 76) in order to transfer rotational power for generating electricity. Air gap plugs 125 expose a view port for inspecting alignment of the rotor 121 and stator 122.

An exemplary turbine may have 7 blades approximately 51 inches in length, tie rods approximately 9 inches in length, a sliding shaft approximately 28 inches in length, a drive shaft approximately 12 inches in length, a stepper-motor actuator model number D-B.125-HT23-8-2N0-TSS/4 with an eight-inch stroke made by Ultra Motion of Cutchogue, N.Y., and an alternator assemble model number 300STK4M made by Alxion Automatique of Colombes, France. This example is not meant to be limiting of the invention, which may be scaled and adapted for a wide variety of wind resources and applications. For larger-scale machines, the actuator 52 may be hydraulic or pneumatic. The Ultra Motion actuator mentioned above has adjustable sensors indicating stop positions at the full open and full closed positions. Additional sensors, or alternate actuators, may be used to provide an electronic measure of shaft position, which in turn is a measure of blade fold angle.

It is believed that operation of the exemplary, folding-blade turbine generator 20 is self-evident from the structure and description above; nevertheless, several observations will be made here to facilitate understanding.

FIG. 5 illustrates a turbine generator with blades 21 in the fully-extended position. Nominally, the nacelle 22 and blades 21 would be oriented so that the direction of a prevailing airflow 25 is generally parallel to the blade rotational axis, which is the rotational axis of the sliding shaft 41 and drive shaft 40. The blades 21 preferably will be on the downwind of the nacelle 22. The aerodynamic shape of the blades 21 causes them to generate a torque about the rotational axis, which in turn rotates the drive hub 30, drive shaft 40, and rotor 121. The rotating fields of the rotor magnets induce electric currents in the coils of the stator 122.

The blades preferably are shaped to be efficient at extracting energy from winds typically blowing at the installation site. The spring 53 preferably is sized to hold the blades 21 in the open position for winds up to a maximum nominal speed corresponding to the turbine generator rated operating speed. In more detail, the spring 53 biases the sliding shaft 41 forward, which in turn biases the sliding hub 42 forward and biases the tie rods 51 outwards. As wind speeds exceed the maximum nominal speed, the axial aerodynamic load on the blades 21 overcomes the force of the spring 53, and the blades will fold. The folding of blades 21 alters the overall geometry of the turbine. As can be seen by comparing FIGS. 2a and 3a, the folding of blades 21 reduces the turbine's exposed cross-section. This folding reduces the area of blades 21 exposed to the wind, which in turn reduces the aerodynamic loading to a point that balances the force of the spring 53. Hydraulic damping may be provided to minimize oscillation. In partially- or fully-folded positions, the blades 21 may continue to absorb energy from the prevailing wind and hence maintain operation. The sliding shaft 41 continues to rotate because screws (FIG. 7, item 77) riding in the slot (FIG. 8, item 84) of the sliding shaft 41 continue to lock the sliding shaft 41 rotationally to the drive shaft 40. The turbine airfoils may be shaped with relatively high exposed areas for operation at relatively low winds, and they can be folded to maintain a rated level of power extraction at high winds without being overpowered or damaged.

The actuator 52 may also be used to fold the blades from the fully-extended position toward the fully-folded position as shown in FIG. 6, or any position in between. In more detail, extension of actuator 52 displaces sliding shaft 41 rearward. Rearward displacement of the sliding shaft 41 moves sliding hub 42 rearward. Tie rods 51 in turn pull the posts (FIG. 10, item 104) of the blades 21 rearward and downward, which pivots the blades 21 about their mounting points 60 in the drive hub 30 toward the folded position. Rearward displacement of the sliding rod 41 also compresses the spring 53.

The actuator 52 may be controlled in a variety of modes. In a first mode, the actuator 52 may be operated manually to set the blades at a desired fold angle. This mode is desirable for maintenance, transport, and diagnostic operation. In a second mode, the turbine generator may monitor rotational speed of the rotating shaft and fold the blades to prevent unsafe operation, such as overspeed. Other safety parameters may be monitored, such as alternator temperature or electrical output level.

The embodiments described above are intended to be illustrative but not limiting. Various modifications may be made without departing from the scope of the invention. The breadth and scope of the invention should not be limited by the description above, but should be defined only in accordance with the following claims and their equivalents.

What is claimed is:

1. A turbine for capturing energy from a fluid moving from an from an upstream direction to a downstream direction, said turbine comprising:
(A) a drive shaft having an axis of rotation, a first end, and a second end remote from the first end along the axis of rotation;
(B) a drive hub coupled to the drive shaft proximately to the first end of the drive shaft; and
(C) a plurality of airfoils, each airfoil having an airfoil axis along a span, each airfoil being coupled to the hub such that
(i) the airfoil is configured to exert a rotational torque about the drive shaft axis of rotation in response to the fluid flow, and
(ii) the airfoil is pivotal between a first position with its airfoil axis generally parallel to the flow direction and a second position with its airfoil axis substantially normal to the flow direction; and
(D) an actuator coupled to the airfoils so as to move the airfoils between the second position toward the first position.

2. A turbine as in claim 1 further comprising a sliding assembly coupling the actuator to the airfoils, said actuator assembly comprising:
(A) a generally-cylindrical sliding shaft disposed concentrically with drive shaft, said sliding shaft having a first end proximate to the drive shaft first and a second end proximate to the drive shaft second end, said sliding shaft being configured to translate along the drive shaft axis of rotation;
(B) a sliding hub coupled to the sliding shaft proximately to the first end;
(C) a plurality of tie rods each coupled to the sliding hub and to an airfoil such that translation of the sliding shaft moves the airfoils between the first and second positions.

3. A turbine as in claim 2 wherein the actuator is disposed to translate the sliding shaft.

4. A turbine as in claim 2 wherein the actuator couples to the sliding shaft proximately to the sliding shaft second end.

5. A turbine as in claim 1 wherein the drive shaft first end is disposed in a downstream direction from the drive shaft second end.

6. A turbine as in claim 1 further comprising a biasing means for biasing the airfoils to the second position.

7. A turbine as in claim 6 wherein the biasing means comprises a spring coupled to the sliding shaft proximately to the sliding-shaft second end.

8. A turbine as in claim 1 wherein the actuator is electrical.

9. A turbine as in claim 1 wherein the actuator is hydraulic.

10. A turbine as in claim 1 wherein the actuator is pneumatic.

11. A turbine as in claim 1 wherein the actuator is operable to place the blades in any of a plurality of positions between the first and second positions.

12. A turbine as in claim 1 wherein the actuator is operable to place the blades in any of a plurality of positions between the first and second positions while the drive shaft is rotating.

13. A turbine as in claim 1 wherein the actuator is operable to move the airfoils toward the first position to prevent unsafe operating conditions.

14. A turbine as in claim 1 further including an electrical generator coupled to the drive shaft.

15. A turbine as in claim 1 further including an electrical generator having a rotor coupled to the drive shaft between the drive shaft first and second ends.

16. A turbine as in claim 1 disposed on a marine structure.

17. A turbine as in claim 1 disposed on a buoyant structure.

18. A turbine as in claim 1 disposed on a buoy adapted for harvesting energy from waves.

19. A turbine as in claim 1 disposed above an ocean.

20. A turbine as in claim 1 disposed in a location susceptible to gale force winds.

21. A turbine as in claim 1 disposed in a location susceptible to hurricane force winds.
